(19) United States
(12) Patent Application Publication
(10) Pub. No.: US 2021/0260759 A1
(43) Pub. Date: Aug. 26, 2021

(54) ESTIMATION OF PAYLOAD ATTACHED TO A ROBOT ARM

(71) Applicant: Universal Robots A/S, Odense S. (DK)

(72) Inventors: Anders Skovgaard KNUDSEN, Odense S. (DK); Andreas Rune FUGL, Odense S. (DK)

(21) Appl. No.: 17/251,990

(22) PCT Filed: Jun. 14, 2019
(86) PCT No.: PCT/EP2019/065725

§ 371 Date: Dec. 14, 2020

(30) Foreign Application Priority Data
Jun. 15, 2018 (EP) 18177968.7

(51) Int. Cl. B25J 9/16; B25J 13/08; G05B 19/4155

(52) U.S. Cl. CPC B25J 9/1638; B25J 13/085; G05B 2219/50391; G05B 2219/37621; G05B 2219/39529; G05B 19/4155

(57) ABSTRACT

Methods and robot, where payload information of a payload attached to a robot tool flange of a robot arm are obtained by arranging the robot tool flange in a plurality of different orientations in relation to gravity; obtaining the force and the torque provided to the robot tool flange by gravity acting on the payload using a force torque sensor arranged at the robot tool flange; obtaining the mass of the payload based on the obtained forces obtained at at least two of the different orientations. The dependent claims describe possible embodiments of the robot and methods according to the present invention.

### FIELD OF THE INVENTION

The present invention relates to a method of estimating payload information of a payload attached to a robot tool flange of a robot arm, where the robot arm comprises a plurality of robot joints connecting a robot base and the robot tool flange.

### BACKGROUND OF THE INVENTION

Robot arms comprising a plurality of robot joints and links where motors can rotate the joints in relation to each other are known in the field of robotics. Typically, the robot arms comprise a robot base which serves as mounting base for the robot arm and robot tool flange whereto various tools can be attached. Typically, a controller is configured to control the robot joints in order to move the robot tool flange in relation to the base. For instance, in order to instruct the robot to carry out a number of working instructions.

The robot controller is configured to control the robot joints based on a dynamic model of the robot arm as known in the prior art, where the dynamic model defines a relationship between the forces acting on the robot arm and the resulting accelerations of the robot arm. Typically, the dynamic model comprises a kinematic model of the robot arm, which defines a relationship between the different parts of the robot arm, such as joints of the robot at various joint angles and a knowledge about mass and inertia of the robot arm, etc. The kinematic model comprises information of the robot arm such as, length, size of the joints and links and can for instance be described by Denavit-Hartenberg parameters or like. The dynamic model makes it possible for the controller to calculate which torque the joint motors shall provide in order to move the robot joints and to overcome the gravitational effect on the robot arm.

On many robot arms it is possible to attach various end effectors to the robot tool flange, such as grippers, vacuum grippers, magnetic grippers, screwing machines, welding equipment, dispensing systems, visual systems etc. When providing such end effector, it is necessary to provide estimation of the payload that such end effector provides to the robot arm. Typically, the user manually enters the payload information into the kinematic model whereafter the controller can take the payload into account when controlling the robot. Typically, the payload information comprises information in relation to the weight and pose of the payload, where pose of the payload relates to the position and orientation of the payload in relation to the robot tool flange. The pose can for instance be indicated at the position of the center of mass of the payload in relation to the robot tool flange.

Many users have difficulties setting the correct payload or ignore/forget to set it at all. Consequently, the controller may not be able to control the robot arm resulting in the robot arm drifting, deviation in safe stops, that safety functions of the robot arm are not functioning properly.

DE 11 2016 002 797 T5 discloses a calibration unit including: an approximate curve generation unit configured to generate an approximate curve based on position information and force information obtained when a tool part is rotated in accordance with an attitude command value; a bias value estimation unit configured to estimate the bias value of the force information based on the approximate curve, the position information, and the force information; a mass/center-of-gravity position estimation unit configured to remove the bias value from the force information, and to calculate a mass and a center-of-gravity position vector of the hand tip load based on the obtained force information; and an external force component calculation unit configured to subtract the bias value and the gravity action component of the hand tip load from the force information based on the bias value, and the mass and the center-of-gravity position vector. The mass/center-of-gravity position estimation unit is configured to to calculate a mass and a center-of-gravity position vector of the hand tip load based on the obtained force information, fore the force information have been obtained by aligning a sensor axis of a force sensor with gravity and rotating the force sensor around an axle perpendicular with gravity. It is difficult for a user to precisely align the sensor axis of the force sensor with gravity and ensure proper alignment while rotating the force sensor.

JP 2012 040634 discloses a calibration device and a method for a power-controlled robot which, even if the installation precision of the robot is low, enable the calibration of necessary parameters with an installation error taken into consideration, where tool is attached to the front end of a robot arm that acts three-dimensionally, via a power sensor. A robot controller makes the robot arm act in a plurality of postures and obtains a measurement value by the power sensor and posture data of the power sensor when obtaining the measurement value. A calculating device calculates a plurality of parameters including the weight of the tool, a gravity direction vector, and a tool gravity center position vector.

### SUMMARY OF THE INVENTION

The object of the present invention is to address the above described limitations with the prior art or other problems of the prior art. This is achieved by the methods and robot according to the independent claims, where payload information of a payload attached to a robot tool flange of a robot arm are obtained by arranging the robot tool flange in a plurality of different orientations in relation to gravity; obtaining the force and the torque provided to the robot tool flange by gravity acting on the payload using a force-torque sensor arranged at the robot tool flange; obtaining the mass of the payload based on the obtained forces obtained at at least two of the different orientations, where the angle between the robot tool flange and gravity is different for each of the different orientations. The dependent claims describe possible embodiments of the robot and methods according to the present invention. The advantages and benefits of the present invention are described in the detailed description of the invention.

### BRIEF DESCRIPTION OF THE DRAWINGS

FIG. 1 illustrates robot arm configured for of obtaining payload information of a payload attached to the robot tool flange of the robot arm;

FIG. 2 illustrates a flow diagram of an embodiment of obtaining payload information of a payload attached to a robot tool flange of the robot arm;

FIG. 3 illustrates a flow diagram of another embodiment of obtaining payload information of a payload attached to a robot tool flange of the robot arm;

FIG. 4 illustrates a flow diagram of an embodiment of a step of obtaining the mass of a payload attached to a robot tool flange of the robot arm;

FIG. 5 illustrates a flow diagram of an embodiment of a step of obtaining the pose of a payload attached to a robot tool flange of the robot arm;

FIGS. 6a and 6b illustrate a display screen of an interface of a robot arm obtaining payload information;

FIGS. 7a and 7b illustrate a different display screen of an interface of a robot arm obtaining payload information; and

FIGS. 8a, 8b and 8c illustrate a different display screen of an interface of a robot arm obtaining payload information.

### DETAILED DESCRIPTION OF THE INVENTION

The present invention is described in view of exemplary embodiments only intended to illustrate the principles of the present invention. The skilled person will be able to provide several embodiments within the scope of the claims. Throughout the description, the reference numbers of similar elements providing similar effects have the same last two digits. Further it is to be understood that in the case that an embodiment comprises a plurality of the same features then only some of the features may be labeled by a reference number.

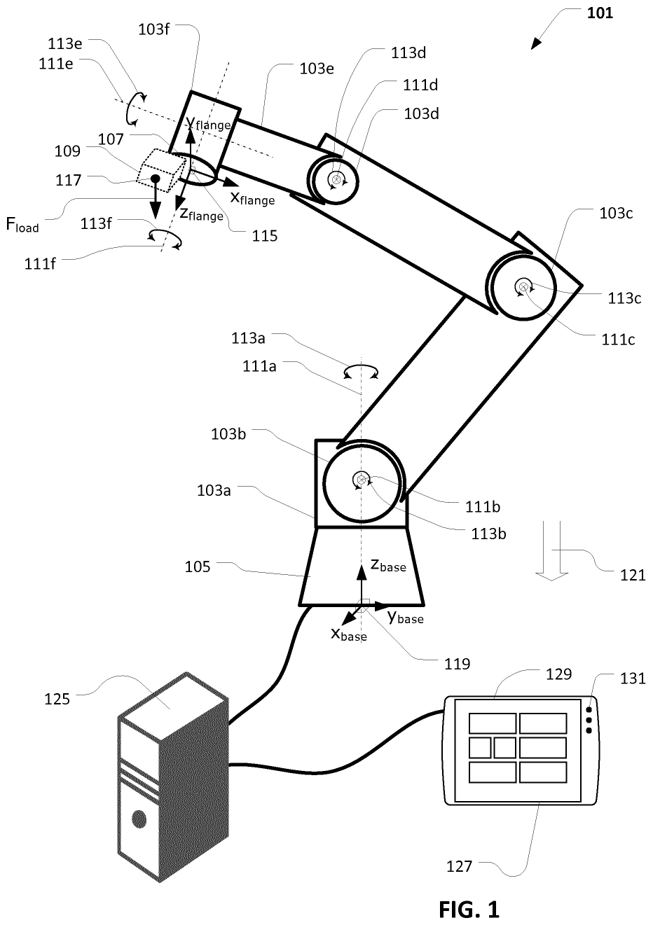

FIG. 1 illustrates a robot arm 101 comprising a plurality of robot joints 103a, 103b, 103c, 103d, 103e connecting a robot base 105 and a robot tool flange 107, where a payload 109 (illustrated in dotted lines) is attached to the robot tool flange. A base joint 103a is configured to rotate the robot arm around a base axis 111a (illustrated in dashed dotted lines) as illustrated by rotation arrow 113a; a shoulder joint 103b is configured to rotate the robot arm around a shoulder axis 111b (illustrated in dashed dotted lines) as illustrated by rotation arrow 113b; an elbow joint 103c is configured to rotate the robot arm around a elbow axis 111c (illustrated in dashed dotted lines) as illustrated by rotation arrow 113c, a first wrist joint 103d is configured to rotate the robot arm around a first wrist axis 111d (illustrated in dashed dotted lines) as illustrated by rotation arrow 113d and a second wrist joint 103e is configured to rotate the robot arm around a second wrist axis 111e as illustrated by rotation arrow 113e. Robot joint 103f is a tool joint comprising the robot tool flange 107, which is rotatable around a tool axis 111f (illustrated by a dashed dotted line) as illustrated by rotation arrow 113f. The illustrated robot arm is thus a six-axis robot arm with six degrees of freedom, however it is noticed the present invention can be provided in robot arms comprising less or more robot joints.

The robot arm is connected to and controlled by a controller 125 comprising in interface device 127 enabling a user to control and program the robot arm. The controller can be provided a computer with a control software installed there on and can be provided as an external device as illustrated in FIG. 1 or as a device integrated into the robot arm. The interface device can for instance be provided a teach pendent as known from the field of industrial robotics which can communicate with the controller via wired or wireless communication protocols. The interface device can for instanced comprise a display 129 and a number of input devices 131 such as buttons, sliders, touchpads, joysticks, track balls, gesture recognition devices, keyboards etc. The display may be provided as a touch screen acting both as display and input device.

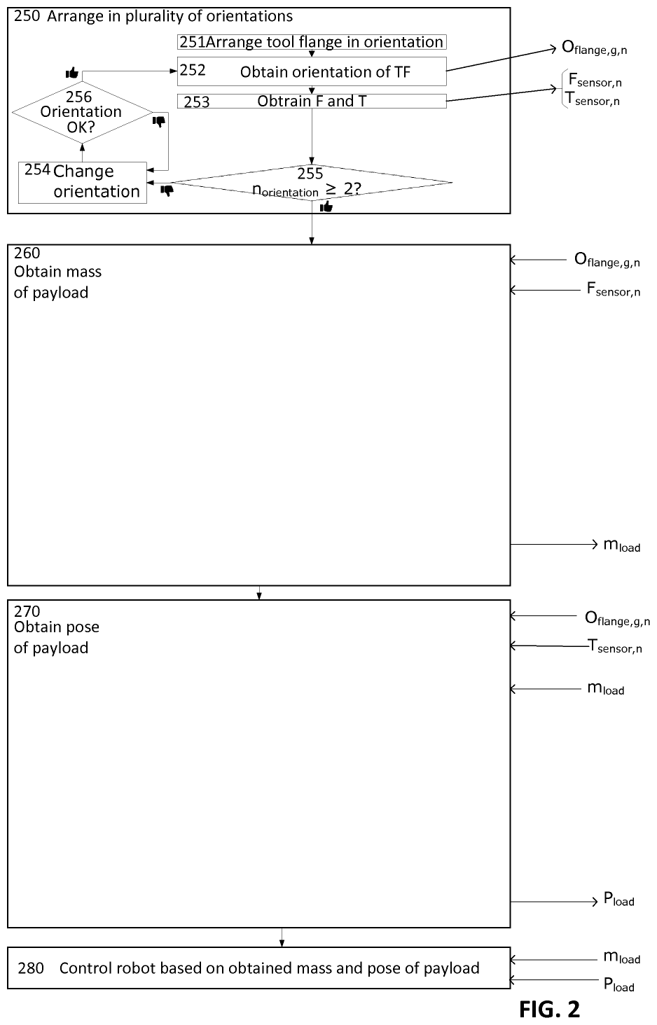

The controller is configured to control the robot joints based on a kinematic model of the robot arm as known in the prior art. Additionally the controller is configured to control the robot arm based on payload information of a payload 109 attached to the robot tool flange, where the payload information indicates the mass and pose of the payload in relation to the robot tool flange. Further the controller is configured to obtain the mass and pose of the payload in relation to the robot tool flange based on forces and torques provided to the robot tool flange when the payload attached to the robot tool flange, where the controller is configured to obtain the forces and torques from a force-torque sensor attached to the robot tool flange and at a plurality of different orientations of the robot tool flange in relation to gravity. The force-torque sensor can be provided as a force torque sensor disclosed by WO2014/110682A1, U.S. Pat. No. 4,763,531, US2015204742. The controller can be configured to obtain the mass and pose of the payload utilizing the method described here below and illustrated in connection with FIGS. 2-5.

The following paragraphs [0013] to [0023] introduce a number of terms used to describe the principles of the present invention.

A robot tool flange coordinate system 115 having origin at the reference point and defining three coordinate axis x_{flange}, y_{flange}, z_{flange}. In the illustrated embodiment the origin of the robot tool flange coordinate system has been arranged on the tool flange axis 111f with one axis (z_{flange}) parallel with tool flange axis and at the outer surface of the robot tool. A position in the robot tool flange coordinate system can be defined as a position vector:

$$\vec{{P}^{flange}} = ( \begin{matrix}{x}^{flange} \\ {y}^{flange} \\ {z}^{flange}\end{matrix} ) \qquad eq . 1$$

where x^{flange}, y^{flange} and z^{flange} indicates the coordinates of the position in the robot tool coordinate system. It is to be understood that the robot tool flange coordinate system can be defined in relation to the robot base in any desired way.

A robot base reference coordinate system 119 has been defined in relation to the robot base and is defined by three coordinate axis x_{base}, y_{base}, z_{base}. In the illustrated embodiment the origin of the base coordinate system has been arranged on the base axis 111a with one axis (z_{base}) parallel with the base axis and at the bottom part of the base. A position in the robot base reference coordinate system can be defined as a position vector:

$$\vec{{P}^{b a s e}} = ( \begin{matrix}{x}^{b a s e} \\ {y}^{b a s e} \\ {z}^{b a s e}\end{matrix} ) \qquad eq . 2$$

where x^{base}, y^{base} and z^{base} indicate the coordinates of the position in the base coordinate system. It is to be understood that the robot base coordinate system can be defined in relation to the robot base in any desired way.

Based on a kinematic model of the robot it is possible to transform any position coordinate defined in the base reference coordinate system by using:

\vec{p^{flange}}=T_{base}^{flange}·\vec{p^{base}} eq. 3

where T_{base}^{flange} is a transformation matrix bringing a vector in the robot base coordinate system to a vector in the robot tool flange coordinate system.

A vector in the robot base coordinate system can be rotated into the robot tool flange coordinate system using:

\vec{p^{flange}}=R_{base}^{flange}·\vec{p^{base}} eq. 4

where R_{base}^{flange} is a rotational matrix rotating a vector in the robot base coordinate system into a vector in the robot tool flange coordinate system. The rotational matrix R_{base}^{flange} can be found based on the kinematic model of the robot and will change with changing positions of the robot arm.
It is also possible to rotate a vector in the robot tool flange coordinate system into a vector in the robot base coordinate system by:

$$\begin{matrix}\vec{{P}^{b a s e}} = {R}_{flange}^{base} \cdot \vec{{P}^{flange}} \\ {[ {R}_{base}^{flange} ]}^{T} \cdot \vec{{P}^{flange}}\end{matrix} \qquad eq . 5$$

The payload 109 has a mass m_{load} and pose in relation to the robot tool flange P_{load}. The pose of the payload in relation to the robot tool flange indicates the position and orientation of the payload in relation to the robot tool flange for instance in relation to a robot tool flange reference point. The robot tool flange reference point can be defined at the origin of the robot tool flange reference coordinate system 115. The pose of the payload can for instance be indicated as a positional vector \vec{P_{load}} indicating the position of payload's center of mass 117 in relation to the robot tool flange reference point for as:

$$\vec{{P}_{load}^{flange}} = ( \begin{matrix}{x}_{load}^{flange} \\ {y}_{load}^{flange} \\ {z}_{load}^{flange}\end{matrix} ) \qquad eq . 6$$

where x_{load}^{flange}, y_{load}^{flange} and z_{load}^{flange} indicate the coordinates of the center of mass of the payload in the robot tool flange coordinate system. The payload is illustrated as an arbitrary box however it is to be understood that the payload can have many different shapes and be provided as any components which can be attached to the tool flange of the robot for instance end effectors as grippers, vacuum grippers, magnetic grippers, screwing machines, welding equipment, dispensing systems, visual systems etc.

The direction of gravity 121 has also been illustrated a as gravity vector in the robot base coordinate system can be defined as:

$$\vec{{G}^{b a s e}} = ( \begin{matrix}{g}_{x}^{b a s e} \\ {g}_{y}^{b a s e} \\ {g}_{z}^{b a s e}\end{matrix} ) \qquad eq . 7$$

where gₓ^{base}, g_{y}^{base}, g_{z}^{base} indicate the magnitude of the gravity along the axis of the robot base coordinate system. In the illustrated embodiment the robot arm is arranged in a position with the base axis is aligned with gravity, thus gravity only contributes with a component in the negative direction of the z_{base} axis, thus:

$$\vec{{G}_{f ιg .1}^{b a s e}} = ( \begin{matrix}0 \\ 0 \\ - 9 \text{,} 82 [ m \text{/} {s}^{2} ]\end{matrix} ) \qquad eq . 8$$

where [symbol] is the gravity vector acting on the robot arm illustrated in FIG. 1. It is to be understood that the robot arm can be mounted in any orientation in relation to gravity resulting in a different gravity vector \vec{G^{base}}.

The gravity vector in the robot base coordinate system can be rotated into a gravity vector defined in tool flange base coordinate system using:

and the opposite rotation:

$$\begin{matrix}\vec{{G}^{b a s e}} = {R}_{flange}^{base} \cdot \vec{{G}^{flange}} \\ {[ {R}_{base}^{flange} ]}^{T} \cdot \vec{{G}^{flange}}\end{matrix} \qquad eq . 10$$

The robot tool flange comprises a force-torque sensor (not shown) integrated into the robot tool flange. The force-torque sensor is configured to indicate the forces and torques applied to the robot tool flange in relation to a reference point which in this application is coincident with the origin of the robot tool flange coordinate system. However, the force-torque sensor can indicate the force-torque applied to the robot tool flange in relation to any point which can be linked to the robot tool flange coordinate system. In one embodiment the force-torque sensor is a six-axis force-torque sensor configured to indicate the forces along and the torques around three perpendicular axis. For instance the force-torque sensor can indicate a force vector in the robot tool flange coordinate system:

$$\vec{{F}_{sensor}^{flange}} = ( \begin{matrix}{F}_{x , sensor}^{flange} \\ {F}_{y , sensor}^{flange} \\ {F}_{z , sensor}^{flange}\end{matrix} ) \qquad eq . 11$$

Where F_{x,sensor}^{flange} is the indicated force along the x_{flange} axis, F_{y,sensor}^{flange} is the indicated force along the y_{flange} axis and F_{z,sensor}^{flange} is the indicated force along the z_{flange} axis. Also, the force-torque sensor can indicate a torque vector in the robot tool flange coordinate system:

$$\vec{{T}_{sensor}^{flange}} = ( \begin{matrix}{T}_{x , sensor}^{flange} \\ {T}_{y , sensor}^{flange} \\ {T}_{z , sensor}^{flange}\end{matrix} ) \qquad eq . 12$$

where T_{x,sensor}^{flange} is the indicated torque around the x_{flange} axis, T_{y,sensor}^{flange} is the indicated torque around the y_{flange} axis and T_{z,sensor}^{flange} is the indicated torque around the z_{flange} axis.

Gravity provides a gravity force \vec{F_{load}} on the payload in the direction of the gravity. The gravity force in the robot base coordinate system can be found by:

\vec{F_{load}^{base}}=m_{load}·\vec{G^{base}}, eq. 13

where m_{load} is the mass of the payload and \vec{G^{base}} the gravity vector in the robot base coordinate system and in the robot tool flange coordinate system the gravity force can be found by

\vec{F_{load}^{flange}}=m_{load}·\vec{G^{flange}}=m_{load}·R_{base}^{flange}·\vec{G^{base}}=R_{base}^{flange}·\vec{F_{load}^{base}} eq. 14

The gravity on the payload also results in a toque provided to the robot tool flange which in relation to the robot tool flange coordinate system and can be found by:

\vec{T_{load}^{flange}}=(\vec{P_{load}^{flange}}×\vec{G^{flange}})·m_{load}, eq. 15

where m_{load} is the mass of the payload and \vec{G^{flange}} the gravity vector in the robot tool flange coordinate system.

The method according to the present invention can be implemented via the control software of the robot arm whereby the payload information of the payload attached to the robot tool flange can be determined in a fast, easy and precise way. Consequently, the robot arm will be functionating more accurately as the control software of the robot arm can take the payload into account when controlling the robot. The method according to the present invention also makes it possible to determine the payload information of payloads having complex forms.

FIG. 2 illustrates a flow diagram of the method of obtaining payload information of a payload attached to a robot tool flange of a robot arm according to the present invention. The robot arm comprises a plurality of robot joints connecting a robot base and the robot tool flange and corresponds to the robot arm disclosed in FIG. 1. The method comprises a step 250 of arranging the robot tool flange in a plurality of different orientations, a step 260 of obtaining the mass of the payload, a step 270 of obtaining the pose of the payload comprises an optional step 280 of controlling the robot based on the obtained payload information.

In step 250 the robot tool flange is arranged in a plurality of different orientations where the number of different orientations, nₒᵣᵢₑₙₜₐₜᵢₒₙ, of the robot tool flange is at least two. At each of the orientations the force and torque provided to the robot tool flange due to gravity acting on the payload is obtained using a force-torque sensor arranged at the robot tool flange.

In the illustrated embodiment, step 250 comprises a step 251 of arranging the robot tool flange in a first orientation for instance by a user manipulating the joints of the robot to arrange the robot tool flange in the first orientation, a user controlling the orientation of the robot tool flange using an interface device 127, an automatic program executed by the controller of the robot or combinations thereof.

Once the robot tool flange has been arranged in an orientation, a step 252 of obtaining the orientation of the robot tool flange 107 (TF) in relation to gravity is performed. The orientation of the robot tool flange O_{flange,g,n} in relation to gravity at the n^{th} orientation can be obtained as any parameter from which the orientation of the robot tool flange in relation to gravity can be obtained. The orientation of the robot tool flange O_{flange,g,n} can for instance be stored in a memory (not shown) of the robot arm. For instance, the orientation of the robot tool flange O_{flange,g,n} can be obtained by obtaining the angular position of each of the robot joints and then using the kinematic model of the robot, the orientation of gravity in the robot base coordinate system to obtaining the orientation the robot tool flange in relation to gravity. For instance, the orientation of the robot tool flange may be indicated as the origin of the robot tool flange coordinate system and the direction of one of the three coordinate axis x_{flange}, y_{flange}, z_{flange} of the robot tool flange coordinate system. In another embodiment the orientation of the robot tool flange can be obtained using a gravity sensor arranged at the robot joint comprising the robot tool flange. Such gravity sensor can indicate the direction of gravity in relation to the robot tool flange and thereby the orientation of the robot tool flange can be obtained based on such gravity sensor. Further in embodiments where the robot tool flange is automatically arranged in an orientation based on a program executed by the controller of the robot the orientation can be obtained based on the program instructions. The orientation of the robot tool flange O_{flange,g} can also be indicated as the gravity vector \vec{G^{flange,n}} in the robot tool flange coordinate system at orientation n. The gravity vector \vec{G^{flange,n}} at the n orientation can be obtained by a gravity sensor at the robot joint of the robot tool flange or by using eq. 9.

Once the robot tool flange has been arranged in an orientation, a step 253 of obtaining the force and torque provided to the robot tool flange due to gravity acting on the payload is obtained using a force-torque sensor arranged at the robot tool flange, where the obtained force at the n^{th} orientation F_{sensor,n} and torque at the n^{th} orientation T_{sensor,n} can be stored in a memory of the robot arm. The force-torque can be integrated into the robot tool flange which ensures that the force-torque sensor is present and properly integrated into the robot arm by the robot arm provider. Alternatively, the force torque sensor can be provided as an external force torque sensor which can be attached to the robot tool flange. In such an embodiment the payload of the force torque sensor needs to be provided manually into the control software of the robot arm.

In one embodiment the force-torque sensor is provided as a six-axis force torque sensor which obtains the forces and torques provided to the force-torque sensor in relation to three basis coordinate axis. The force-torque may for instance be aligned with the robot tool flange coordinate system 115 and indicate the applied force along and the torques around the axis x_{flange}, y_{flange}, z_{flange}. Thus, the forces obtained at orientation n can be indicated as:

$$\vec{{F}_{sensor}^{flange , n}} = ( \begin{matrix}{F}_{x , sensor}^{flange , n} \\ {F}_{y , sensor}^{flange , n} \\ {F}_{z , sensor}^{flange , n}\end{matrix} ) \qquad eq . 16$$

where F_{x,sensor}^{flange,n} is the indicated force along the x_{flange} axis at the n^{th} orientation, F_{y,sensor}^{flange,n} is the indicated force along the y_{flange} axis at the n^{th} orientation and F_{z,sensor}^{flange,n} is the indicated force along the z_{flange} axis at the n^{th} orientation; and the torques obtained at the n^{th} orientation can be indicated as:

$$\vec{{T}_{sensor}^{flange , n}} = ( \begin{matrix}{T}_{x , sensor}^{flange , n} \\ {T}_{y , sensor}^{flange , n} \\ {T}_{z , sensor}^{flange , n}\end{matrix} ) \qquad eq . 17$$

where T_{x,sensor}^{flange,n} is the indicated torque around the x_{flange} axis at the n^{th} orientation, T_{y,sensor}^{flange,n} is the indicated torque around the y_{flange} axis at the n^{th} orientation and T_{z,sensor}^{flange,n} is the indicated torque around the z_{flange} axis at the n^{th} orientation.

Step 255 is a step of verifying that forces and torques provided to the robot tool flange by gravity have been obtained at at least two different orientations of the robot tool flange in relation to gravity. This can be achieved by incrementing a counter nₒᵣᵢₑₙₜₐₜᵢₒₙ by 1 when the orientation, force and torque have been obtained in step 252 and 253 and then testing if the counter nₒᵣᵢₑₙₜₐₜᵢₒₙ is equal to or larger than the desired number of orientations (in the illustrated embodiment 2). If the desired number of orientations has not been reached (indicated by a thumbs-down symbol) at step 254 of changing the orientation of the robot tool flange is initiated otherwise (indicated by a thumbs-up symbol) the method continues to the next step.

The step 254 of changing the orientation of the robot tool flange can be achieved by a user manipulating the joints of the robot to arrange the robot tool flange in a new orientation, a user controlling the orientation of the robot tool flange using an interface device 127, an automatic program executed by the controller of the robot or combinations thereof. The orientation of the robot tool flange is changed by rotating the tool flange in relation to gravity meaning that the angle between the robot tool flange and gravity is different for the plurality of different orientations. Once the orientation of the robot tool flange has been changed; the orientation of the robot tool flange and the forces provided to the robot tool flange of the robot is then obtained at the new orientation by repeating steps 252 and 253.

In one embodiment the step 254 of changing the orientation of the robot tool flange comprises a step of rotating the robot tool flange around an axis non-parallel with and non-perpendicular to gravity. This ensures that the angle of the robot tool flange in relation to gravity is changed.

An optional step 256 of verifying the orientations of the robot tool flange have been illustrated as part of step 250. In this embodiment step 256 is carried out as part of the loop comprising step 254. Step 256 verifies that the new orientation of the robot tool flange is OK. For instance, by checking that the angle between the robot tool flange and gravity of the new orientation differs from the angle of the robot tool flange of the previous orientations. Such verification makes it possible to ensure that the payload information can be obtained based on the obtained force and torque. It is noted that the verification of the orientations of the robot tool flange can be performed at other positions in the flow diagram. For instance, the step 256 can be provided as a verification carried out at the end of step 250, when the force and torque have been obtained at all orientations. The verification step can then comprise a verification of all the orientations and/or also the obtained forces and torques.

Step 250 results in an indication of a plurality of different orientations of the robot tool flange and for each of the different orientations an indication of the force and toques applied to the robot tool flange due to gravity acting on a payload attached to the robot tool flange.

The mass m_{load} of the payload is then obtained in step 260 based on the orientations of the robot tool flange O_{flange,g,n} obtained in step 252 and corresponding to the forces F_{sensor,n} obtained in step 253. This can for instance be achieved by using eq. 13, the obtained forces at the n^{th} orientation from eq. 16 and the orientation of gravity at the n^{th} orientation, \vec{G^{flange,n}}, where the rotational matrix R_{base}^{flange} can be obtained based on the kinematic model of the robot and obtained angles of the robot joint at orientation n. The obtained mass m_{load} can then be stored in a memory of the robot arm.

The pose P_{load} of the payload is then obtained in step 270 based on orientations of the robot tool flange O_{flange,g,n} obtained in step 252, the corresponding torques T_{sensor,n} obtained in step 253 and the mass m_{load} of the payload obtained in step 260. The pose of the payload can for instance be obtained as the position of the center of mass of the payload in relation to the robot tool flange \vec{P_{load}^{flange}}. This can for instance be achieved by using eq. 15, the obtained torques at the n^{th} orientation from eq. 17 and the orientation of gravity at the n^{th} orientation, \vec{G^{flange,n}}, where the rotational matrix R_{base}^{flange} can be obtained based on the kinematic model of the robot and obtained angles of the robot joint at orientation n. The pose of the payload is determined based the at least two orientations the tool flange which ensures that the pose of the payload can be properly obtained, as none working orientations where one axis of the force-torque sensor is parallel to gravity resulting in the fact that the torque in relation to that axis is zero making it impossible to determine the position of the center of mass along that axis due to the missing toque.

Obtaining the pose of the payload based on force-torque measurements at least two orientations of the robot tool flange in relation to gravity, where the orientations differs in having different angels in relation to gravity ensures that the pose of the payload can be determined, as by changing the angle of the robot tool flange between two of the different orientations ensures that the toque around each of the axis x_{flange}, y_{flange}and z_{flange} can be obtained. Additionally, determining the mass and pose of the payload based on at least two orientations the robot tool flange makes it possible to determine the mass and pose of the payload using a less expensive force-torque sensor which typically measures the force and torque in-accurately especially under different working conditions, such as different temperature and humidity. This can be achieved as described in the forthcoming paragraphs. Additionally, by obtaining the force-torque at at least two different orientations of the robot tool flange in relation to gravity ensures that the momentum arm defined as a vector from the robot tool flange coordinate system to the center of mass of the payload in at least one orientation is non-parallel with gravity. As a result, it is ensured that the length of momentum arm can be obtained based on the force-torque measurements obtained at the orientation of the robot tool flange where the momentum arm is non-parallel with gravity.

Step 280 is an optional step of controlling the robot based on the obtained payload information. This can for instance be achieved by adjusting the kinematic model of the robot taking obtained payload information into consideration. Consequently, the controller can thereafter better control the robot arm preventing drifting of the robot arm and deviation in safety stops, where the robot arm is brought to a stop. The safety functions of the robot arm will also be functioning as intended.

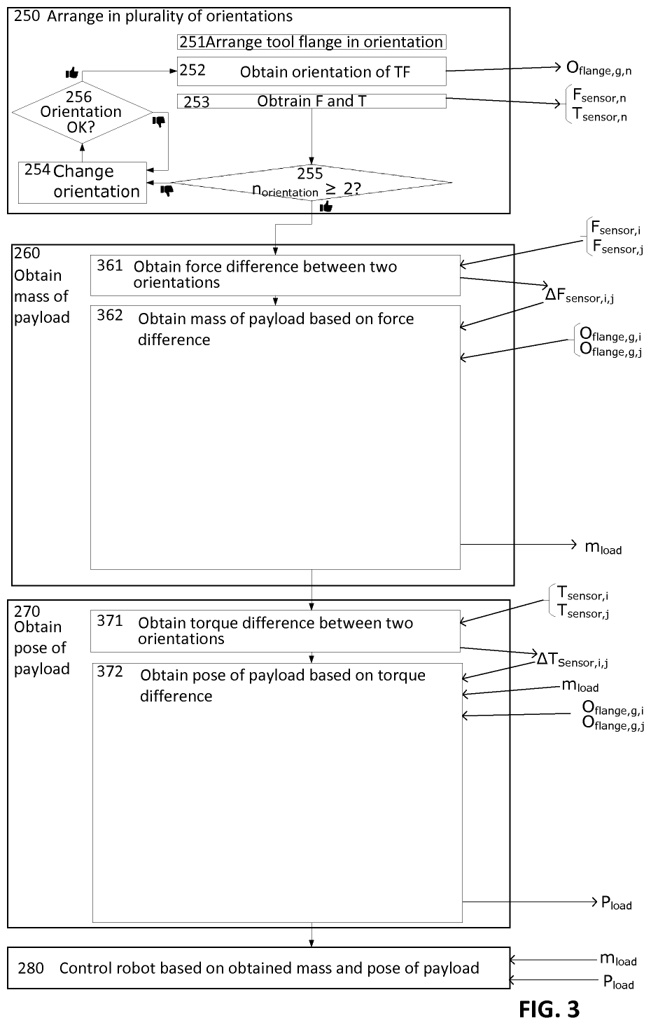

FIG. 3 illustrates a flow diagram of the method of obtaining payload information of a payload attached to a robot tool flange of a robot arm according to the present invention. The method is like the method illustrated in FIG. 2 and similar steps have been given the same reference numbers as in FIG. 2 and will not be described in further detail.

In this embodiment step 260 of obtaining the mass of the payload comprises a step 361 of obtaining an obtained force difference where the obtained force difference is obtained as a difference between two of the obtained forces obtained at two of the different orientations of the robot tool flange:

ΔF_{sensor,i,j}=F_{sensor,i}−F_{sensor,j} eq. 18

where ΔF_{sensor,i,j} is the difference in obtained force between the obtained force F_{sensor,i} at the n^{th} orientation i and the obtained force F_{sensor,j} at the n^{th} orientation j. On vector form and using eq. 16:

$$\begin{matrix}\vec{Δ {F}_{sensor}^{flange , ι , j}} = \vec{{F}_{sensor}^{flange , ι}} - \vec{{F}_{sensor}^{flange , j}} \\ = ( \begin{matrix}{F}_{x , sensor}^{flange , i} \\ {F}_{y , sensor}^{flange , i} \\ {F}_{z , sensor}^{flange , i}\end{matrix} ) - ( \begin{matrix}{F}_{x , sensor}^{flange , j} \\ {F}_{y , sensor}^{flange , j} \\ {F}_{z , sensor}^{flange , j}\end{matrix} )\end{matrix} \qquad eq . 19$$

where F_{x,sensor}^{flange,i} and where F_{x,sensor}^{flange,j} are the obtained force along the x_{flange} axis respectively at n^{th} orientation i and j, F_{y,sensor}^{flange,i} and F_{y,sensor}^{flange,j} are the obtained force along the y_{flange} axis respectively at n^{th} orientation i and j and F_{z,sensor}^{flange,i} and F_{z,sensor}^{flange,j} are the obtained force along the z_{flange} axis respectively at n^{th} orientation i and j.

In this embodiment step 260 of obtaining the mass m_{load} of the payload comprises a step 362 of determining the mass of the payload based on the obtained force difference force ΔFₛₑₙₛₒᵣ and the orientations O_{flange,g,i}, O_{flange,g,j} of the robot tool flange based on which the obtained force difference is obtained. O_{flange,g,i} indicate the orientation of the robot tool flange at the n^{th} orientation i and O_{flange,g,i} indicate the orientation of the robot tool flange at the n^{th} orientation j.

The mass of the payload m_{load} can for instance be obtained by using eq. 14 to replace each of terms \vec{Fₛₑₙₛₒᵣ^{flange,l}}, \vec{Fₛₑₙₛₒᵣ^{flange,J}} of obtained forces respectively at the n^{th} orientations i and j with the terms m_{load}·\vec{G^{flange,l}}, and m_{load}·\vec{G^{flange,J}}, where \vec{G^{flange,l}}, \vec{G^{flange,J}} indicate the orientations of the gravity vector in the robot tool coordinate system at the n^{th} orientations i and j.

Obtaining the mass of the payload based on the obtained force difference between two of the obtained forces obtained at two of the different orientations the robot tool flange makes it possible to obtain the mass of the payload using less expensive force-torque sensor where the absolute accuracy varies under different working conditions, such as different temperature and humidity. Assuming the force measurements made at the different orientations have been made under the same working conditions makes it possible to assume that the offset in relation to the absolute force is the same for the measurements made at the two different positions. This offset can be eliminated to determine the mass of the payload based on the difference in obtained forces instead or in addition to obtaining the mass based a force measurement at a single orientation.

In this embodiment step 270 of obtaining the pose of the payload comprises a step 371 of obtaining an obtained torque difference where the obtained torque difference is obtained as a difference between two of the obtained torques obtained at two of the different orientations the robot tool flange:

ΔT_{sensor,i,j}=T_{sensor,i}−T_{sensor,j} eq. 20

where ΔTₛₑₙₛₒᵣ is the difference in obtained torque between the obtained torque T_{sensor,i} at the n^{th} orientation i and the obtained torque T_{sensor,j} at the n^{th} orientation j. On vector form and using eq. 17:

$$\begin{matrix}\vec{Δ {T}_{sensor}^{flange , ι , j}} = \vec{{T}_{sensor}^{flange , ι}} - \vec{{T}_{sensor}^{flange , j}} \\ = ( \begin{matrix}{T}_{x , sensor}^{flange , i} \\ {T}_{y , sensor}^{flange , i} \\ {T}_{z , sensor}^{flange , i}\end{matrix} ) - ( \begin{matrix}{T}_{x , sensor}^{flange , j} \\ {T}_{y , sensor}^{flange , j} \\ {T}_{z , sensor}^{flange , j}\end{matrix} )\end{matrix} \qquad eq . 21$$

where T_{x,sensor}^{flange,i} and where T are the obtained torques around the x_{flange} axis respectively at n^{th} orientation i and j, T_{y,sensor}^{flange,i} and where T_{y,sensor}^{flange,j} are the obtained torque along the y_{flange} axis respectively at n^{th} orientation i and j and T_{z,sensor}^{flange,i} and where T_{z,sensor}^{flange,j} are the obtain torque along the z_{flange} axis respectively at n^{th} orientation i and j.

In this embodiment step 270 of obtaining the pose P_{load} of the payload comprises a step 372 of determining the pose of the payload based on the obtained mass of the payload m_{load}, the obtained torque difference ΔTₛₑₙₛₒᵣ and the orientations O_{flange,g,i}, O_{flange,g,j} of the robot tool flange based on which the obtained torque difference is obtained.

The pose of the payload P_{load} can for instance be obtained by using eq. 15 to replace each of terms \vec{Tₛₑₙₛₒᵣ^{flange,l}}, \vec{Tₛₑₙₛₒᵣ^{flange,J}} of the obtained torques respectively at the n^{th} orientations i and j with the terms (\vec{P_{load}^{flange,l}}×\vec{G^{flange,l}})·m_{load}, and (\vec{P_{load}^{flange,J}}×\vec{G^{flange,J}})·m_{load}, where \vec{G^{flange,l}}, \vec{G^{flange,J}} indicate the orientation of the robot tool flange in form the gravity vector in the robot tool coordinate system at the n^{th} orientations i and j, and where \vec{P_{load}^{flange,l}}, \vec{P_{load}^{flange,J}} indicate the pose of the payload as the position of the center of mass of the payload in relation to the robot tool flange. \vec{P_{load}^{flange,l}} and \vec{P_{load}^{flange,J}} are identical as they refer to the center of mass of the same payload in relation to the robot tool flange coordinate system.

Obtaining the pose of the payload based on the obtained torque difference between two of the obtained torques obtained at two of the different orientations the robot tool flange makes it possible to obtain the pose of the payload using less expensive force-torque sensor where the absolute accuracy varies under different working conditions, such as different temperature and humidity. Assuming the torque measurements made at the different orientations have been made under the same working conditions makes it possible to assume that the offset in relation to the absolute torque is the same for the measurements made at the two different orientations. This offset can be eliminated to determine the pose of the payload based on the difference in obtained torques.

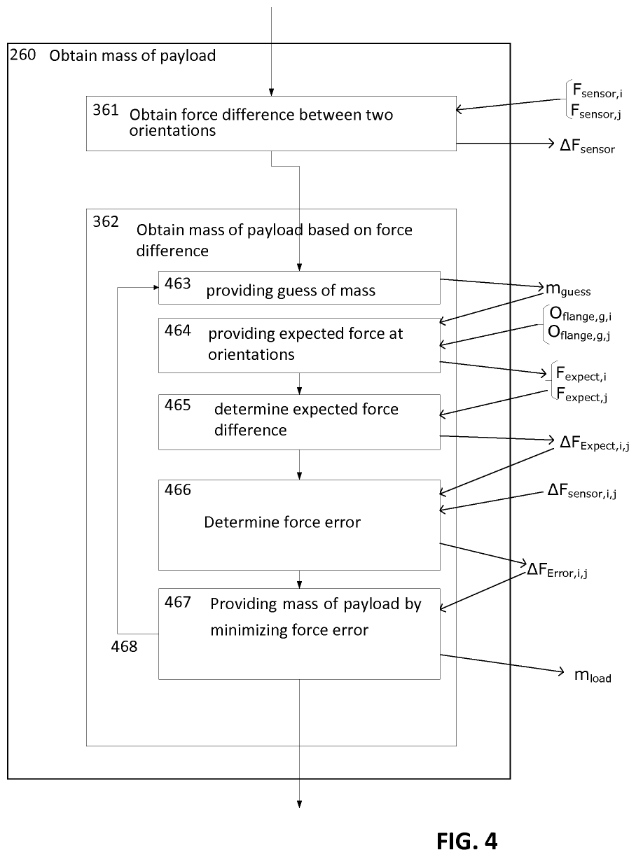

FIG. 4 illustrates a flow diagram of an embodiment of the step 260 of obtaining the mass of the payload. Step 260 is like the step 260 illustrated in FIGS. 2 and 3 and similar steps have been given the same reference numbers as in FIGS. 2 and 3. In this embodiment step 260 comprises:
a step 463 of providing an initial guess of the mass of the payload m_{guess}.
a step 464 for at least two of the different orientations O_{flange,g,i}, O_{flange,g,j} of the robot tool flange providing an expected force F_{expect,i}, F_{expect,j} provided to the robot tool flange by a payload having a mass corresponding to the initial guess of mass, m_{guess}.
a step 465 of determining an expected force difference ΔF_{expect,i,j} between at least two of the expected forces F_{expect,i}, F_{expect,j} at at least two different orientations of the tool flange.
a step 466 of determining a force error ΔF_{error,i,j} indicating the difference between the obtained force difference ΔF_{sensor,i,j} and the expected force difference ΔF_{expect,I,j},
a step 467 of providing the mass m_{load} of the payload by minimizing the force error ΔF_{error,i,j}.
   This makes it possible to provide an estimation of the mass of the payload in situations where an exact solution to the equation cannot be obtained for instance due to inaccuracy of the force-torque measurements. Further the method according to the present invention can easily be implemented into a controller of a robot arm using simple logic and numerical methods, which is easy to implement into standard controllers. Further estimating the mass of the payload based by minimizing the force error also makes it possible to estimated how good the obtained mass of the payload is in relation to the actual mass of the payload.

Step 463 of providing an initial guess of the mass the payload can be implemented by providing a random guess of the mass m_{guess} of the payload, by providing a predetermined guess of the mass of the payload for instance a guess corresponding to half of the robots arm's allowed payload. Also the initial guess of the mass of the payload can be provided based on one of the force measurements which can serve as a realistic guess even when a in less accurate force-torque sensor is used.

The expected forces F_{expect,i}, F_{expect,j} provided in step 464 can be provided by using eq. 14 using the initial guess of mass m_{guess} instead of m_{load}, and and where gravity vector \vec{G^{flange}} is obtained based on the orientations O_{flange,g,i}, O_{flange,g,j} of the robot tool flange as previous described. Consequently at least two expected forces F_{expect,i}, F_{expect,j} are obtained. However, it is to be understood that an expected force can by obtained for each of the orientations of the robot tool flange where the force and torque provided to the robot tool flange have been obtained (step 250).

Step 465 of determining an expected force difference ΔF_{expect,i,j} between at least two of the expected forces F_{expect,i}, F_{expect,j} at at least two different orientations of the tool flange can be implemented by:

ΔF_{expect,i,j}=F_{expect,i}−F_{expect,j} eq. 22

on vector form:

$$\begin{matrix}\vec{Δ {F}_{expect}^{flange , ι , j}} = \vec{{F}_{expect}^{flange , ι}} - \vec{{F}_{expect}^{flange , j}} \\ = ( \begin{matrix}{F}_{x , expect}^{flange , i} \\ {F}_{y , expect}^{flange , i} \\ {F}_{z , expect}^{flange , i}\end{matrix} ) - ( \begin{matrix}{F}_{x , expect}^{flange , j} \\ {F}_{y , expect}^{flange , j} \\ {F}_{z , expect}^{flange , j}\end{matrix} )\end{matrix} \qquad eq . 23$$

where F_{x,expect}^{flange,i} and where F_{x,expect}^{flange,j} are the expected force along the x_{flange} axis respectively at n^{th} orientation i and j, F_{y,expect}^{flange,i} and where F_{y,expect}^{flange,j} are the expected force along the y_{flange} axis respectively at n^{th} orientation i and j and F_{z,expect}^{flange,i} and where F_{z,expect}^{flange,j} are the expected force along the z_{flange} axis respectively at n^{th} orientation i and j.

Step 466 of determining the force error ΔF_{error,i,j} between the obtained force difference ΔFₛₑₙₛₒᵣ and the expected force difference ΔF_{expect} can be carried out by subtracting one of them form the other. For instance, by:

ΔF_{error,i,j}=||\vec{ΔFₛₑₙₛₒᵣ^{flange,l,J}}−\vec{ΔF_{expect}^{flange,l,J}}||² eq. 24

Step 467 of providing the mass of the payload by minimizing the force error can be implemented varying the initial guess of the mass of the payload and repeat the step 464, 465, 466 using a new initial guess of the mass of the payload as indicated by loop 468. The result is that a new force error can be obtained and comparing the force error with the previously obtained force errors it is possible to determine which guess of mass that results in the smallest force error. This can be performed a number of times resulting in a set of initial guess of mass m_{guess,k} with a corresponding force errors ΔF_{error,k} where k is an integer indicating guess number. The mass m_{load} of the payload can be set to be the guess of mass m_{guess,min} resulting in the smallest force error ΔF_{error,min}. Loop 468 can for instance be repeated a number of predetermined times where the guess of mass for instance is changed with a predetermined interval and within a predetermined range of mass. Ideally the force error is zero when the guess of mass m_{guess} matched correct mass m_{load} of the payload. However due to inaccurate force torque measurements this may be difficult to achieve loop 468 can then be repeated until an acceptable level of force error has been obtained.

In an embodiment where the forces in step 250 have been obtained for more than three different orientations of the robot tool flange the force error can be provided as a squared sum of the force errors between each of the different orientations:

ΔF_{error,total}=Σᵢ₌₁ⁿ⁻¹Σⱼ₌ᵢ₊₁ⁿΔF_{error,i,j} eq. 25

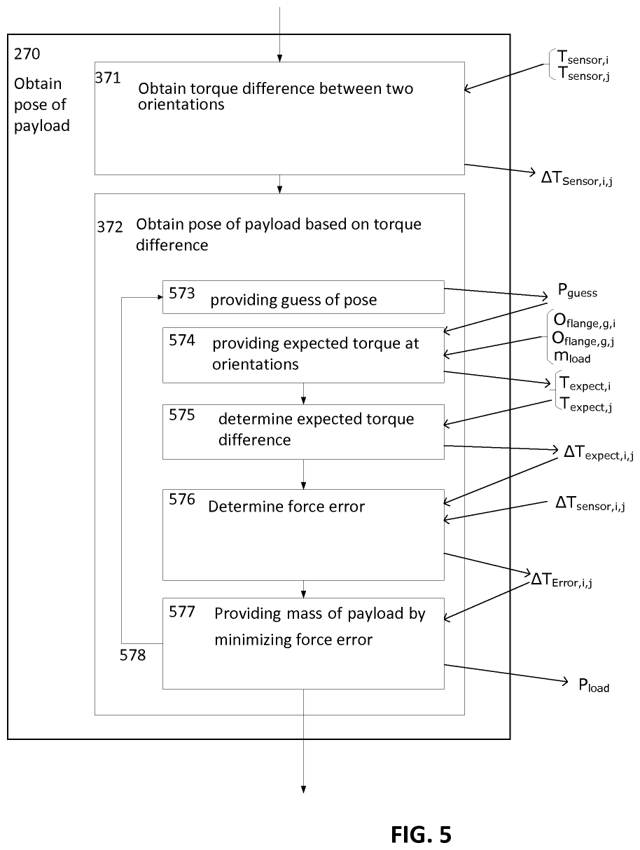

FIG. 5 illustrates a flow diagram of an embodiment of the step 270 of obtaining the pose of the payload. Step 270 is like the step 270 illustrated in FIGS. 2 and 3 and similar steps have been given the same reference numbers as in FIGS. 2 and 3. In this embodiment step 270 comprises:
a step 573 of providing an initial guess of the pose the payload P_{guess}.
a step 574 for at least two of the different orientations O_{flange,g,i}, O_{flange,g,j} of the robot tool flange providing an expected torque T_{expect,i}, T_{expect,j} provided to the robot tool flange by a payload having a pose corresponding to the initial guess of pose, P_{guess}.
a step 575 of determining an expected torque difference ΔT_{expect,i,j} between at least two of the expected torques T_{expect,i}, T_{expect,j} at at least two different orientations of the tool flange.
a step 576 of determining a torque error ΔT_{error,i,j} indicating the difference between the obtained torque difference ΔT_{sensor,i,j} and the expected torque difference ΔT_{expect,i,j},
a step 577 of providing the pose P_{load} of the payload by minimizing the torque error ΔT_{error,i,j}.

This makes it possible to provide an estimation of the pose of the payload in situations where an exact solution for the equation cannot be obtained for instance due to inaccuracy of the force-torque measurements. Further the method according to the present invention can easily be implemented into a controller of a robot arm using simple logic and numerical methods, which is easy to implement into standard controllers. Further estimating the pose of the payload based by minimizing the force error also makes it possible to estimated how good the obtained pose of the payload is in relation to the actual mass of the payload.

Step 573 of providing an initial guess of the pose the payload can be implemented by providing a random guess of the pose P_{guess} of the payload, by providing a predetermined guess of the pose of the payload for instance a guess corresponding to position of the center of mass of the payload at a given position in front of the robot tool flange, a position along the z_{flange} axis. Also the initial guess of the pose of the payload can be provided based on one of the force and toque measurements which can serve as a realistic guess even when a less accurate force-torque sensor is used.

The expected torque T_{expect,i}, T_{expect,j} provided in step 574 can be provided by using eq. 15 using the initial guess of pose P_{guess} instead of P_{load}^{flange} and where gravity vector \vec{G^{flange}} is obtained based on the orientations O_{flange,g,i}, O_{flange,g,j} of the robot tool flange as previously described. The mass of the payload m_{load} obtained in step 260 can be used. Consequently at least two expected torques T_{expect,i}, T_{expect,j} are obtained, however it is to be understood that an expected torque can be obtained for each of the orientations of the robot tool flange where the force and torque provided to the robot tool flange have been obtained (step 250).

Step 575 of determining an expected torque difference ΔT_{expect} between at least two of the expected torques T_{expect,i}, T_{expect,j} at at least two different orientations of the tool flange can be implemented by:

ΔT_{expect,i,j}=T_{expect,i}−T_{expect,j} eq. 26

on vector form:

$$\begin{matrix}\vec{Δ {T}_{expect}^{flange , ι , j}} = \vec{{T}_{expect}^{flange , ι}} - \vec{{T}_{expect}^{flange , j}} \\ = ( \begin{matrix}{T}_{x , expect}^{flange , i} \\ {T}_{y , expect}^{flange , i} \\ {T}_{z , expect}^{flange , i}\end{matrix} ) - ( \begin{matrix}{T}_{x , expect}^{flange , j} \\ {T}_{y , expect}^{flange , j} \\ {T}_{z , expect}^{flange , j}\end{matrix} )\end{matrix} \qquad eq . 27$$

where T_{x,expect}^{flange,i} and where T_{x,expect}^{flange,j} are the expected torque around the x_{flange} axis respectively at n^{th} orientation i and j, T_{y,expect}^{flange,i} and where T_{y,expect}^{flange,j} are the expected torque around the y_{flange} axis respectively at n^{th} orientation i and j and T_{z,expect}^{flange,i} and where T_{z,expect}^{flange,j} are the expected torque around the z_{flange} axis respectively at n^{th} orientation i and j.

Step 576 of determining the torque error ΔT_{error,i,j} between the obtained torque difference ΔT_{sensor,i,j} and the expected torque difference ΔT_{expect,I,j} can be carried out by subtracting one of them form the other. For instance, by:

ΔT_{error,i,j}=||\vec{ΔTₛₑₙₛₒᵣ^{flange,l,J}}−\vec{ΔT_{expect}^{flange,l,J}}||² eq. 28

Step 577 of providing the pose of the payload by minimizing the torque error can be implemented varying the initial guess of the pose of the payload and repeat the step 574, 575, 576 using a new initial guess of the pose of the payload as indicated by loop 578. The result is that a new torque error can be obtained and comparing the torque error with the previously obtained torque errors it is possible to determine which guess of poses that results in the smallest torque error. This can be performed a number of times resulting in a set of initial guesses of pose P_{guess,k} with a corresponding torque errors ΔT_{error,k} where k is an integer indicating guess number. The pose P_{load} of the payload can be set to be the guess of pose P_{guess,min} resulting in the smallest torque error ΔT_{error,min}. Loop 578 can for instance be repeated a number of predetermined times where the guesses of pose for instance is changed with a predetermined interval and within a predetermined range of positions. Ideally the torque error is zero when the guess of pose P_{guess} matched correct pose P_{load} of the payload. However due to inaccurate torque measurements this may be difficult to achieve and loop 578 can then be repeated until an acceptable level of torque error has been obtained.

In an embodiment where the torques in step 250 have been obtained for more than three different orientations of the robot tool flange the torque error can be provided as a squared sum of the torque errors between each of the different orientations:

ΔT_{error,total}=Σᵢ₌₁ⁿ⁻¹Σⱼ₌ᵢ₊₁ⁿΔT_{error,i,j} eq. 29

In one embodiment the step of changing the orientation of the robot tool flange in relation to gravity comprises a step changing the orientation of the robot flange by at least 20 degrees in relation to a least one other orientation of the robot tool flange. This ensures that the force along and torques around the sensing axis of the force-torque sensor has been changed over a range the differences in the obtained forces and torques due to changes in relation to gravity exceed the noise and/or measuring errors of the force-torque measurements obtained by of the force-torque sensor.

In one embodiment the step of arranging the robot tool flange in a plurality of different orientations comprise arranging the robot tool flange in four different orientations in relation to gravity. This ensures that at at least one of the different orientations none of the sensing axis of the force-torque sensor is parallel with gravity thereby avoiding zero torque around a sensing axis which is parallel with gravity.

In one embodiment the step changing the orientation of the robot tool flange in relation to gravity comprises a step changing the orientation of the robot flange between 100-140 degrees in relation to at least one other orientation of the robot flange. Hereby is achieved that the force along and torque around at least one of the sensing axis of the force-torque sensor has opposite signs resulting in a more robust determination the payload information as eventual offset in force-torque sensor along that axis can be eliminated, further this also ensures that the force along and torques around the sensing axis of the force-torque sensor has been changed over a range where the differences in the obtained forces and torques due to changes in relation to gravity exceed measuring errors of the force-torque sensor.

In one embodiment the step of arranging the robot tool flange in a plurality of different orientations comprise arranging the robot tool flange in four different orientations in relation to gravity, where the angle between each of the four different orientations is between 100-140 degrees in relation to the three other orientations. This results in the effect that the obtained forces and torques along the sensing axis of the force-torque sensor is provided over a large range, where at least two of the sensed forces and torques in relation the sensing axis have opposite directions resulting in a robust method of obtaining the payload information. In a more specific embodiment the angle between each of the orientations of the robot tool flange is between 110-130 degrees, and even more specific between 115-125 degrees or 120 degrees.

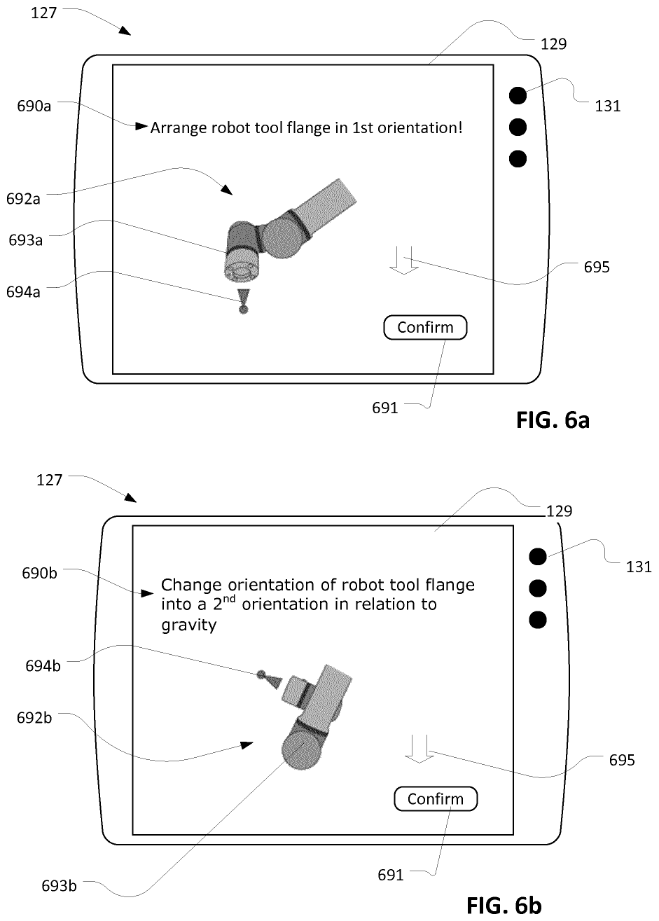

FIGS. 6a and 6b illustrate an interface device 127 of the robot arm illustrated in FIG. 1 and illustrates examples of an embodiment, where the controller during estimation of the payload is configured to provide user instructions to a user. The user instructions serve to instruct the user to change the orientation of the robot tool flange in relation to gravity. In FIG. 6a the user instruction is provided as a command prompt 690a instructing the user to: “Arrange robot flange in 1^{st} orientation!”. Once the user has arranged the robot tool flange in the 1^{st} orientation the controller is configured to obtain the force-torques provided to the robot tool flange using the force-torque sensor as described previously. When the user has arranged the robot tool flange in the first orientation, the user can for instance push a confirmation icon 691 on the touch screen to instruct the controller to obtain the forces and torques provided to the robot tool flange.

Thereafter as illustrated in FIG. 6b a new user instruction is provided as a command prompt 690b instructing the user to: “Change orientation of robot tool flange into a 2^{nd} orientation in relation to gravity”. Once the user has arranged the robot tool flange in the 2^{nd} orientation, the controller is configured to obtain the force-torques provided to the robot tool flange using the force-torque sensor as described previously. Again, the user can push a confirmation icon 691 on the touch screen to instruct the controller to obtain the forces and torques provided to the robot tool flange.

The steps described above can be repeated until the desired number of orientations have been obtained and the controller can obtain the mass and pose of the payload as described previously. It is noticed that in other embodiments the user instructions can be provided using different kinds of interface means, for instance as sound commands.

A first representation 692a of the robot tool flange is shown upon the display and indicates at least one of the different orientations of the robot tool flange. In FIG. 6a, the first representation 692a indicates the desired orientation of the robot tool flange in the 1^{st} orientation and is provided as an image 693a illustrating a possible configuration of the robot arm with the robot tool flange arranged in the 1^{st} orientation. Further an orientation symbol 694a indicating the orientation of the robot tool flange is also shown. A gravity symbol indicating the orientation of gravity 695 can also be provided at the display. In FIG. 6b the first representation 692b indicates the desired orientation of the robot tool flange in the 2^{nd} orientation and is provided as an image 693b illustrating a possible configuration of the robot arm with the robot tool flange arranged in the 2nd orientation and symbol 694b indicates the orientation of the robot tool flange in the 2^{nd} orientation.

The user instructions serve to assist the user when configuration the robot arm controller with payload information and makes it easier for the user to ensure correct determination of the payload information. It is noticed that graphical representations of more than one of the desired orientations of the robot tool flange can be shown together on the screen in order to provide an overview of the orientations where the forces and torques need to be obtained.

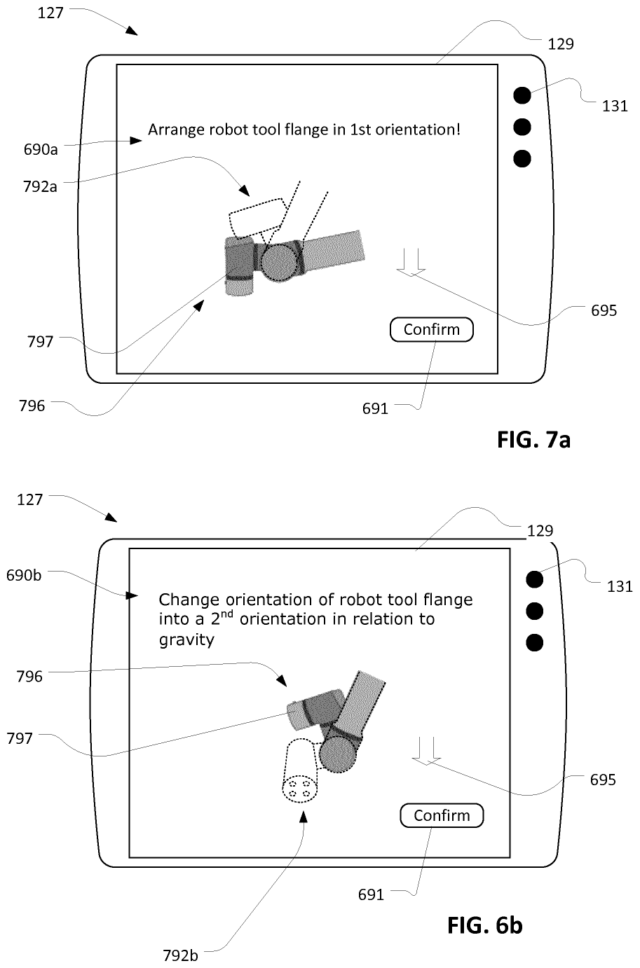

FIGS. 7a and 7b illustrate an interface device 127 of the robot arm illustrated in FIG. 1 and illustrates examples of an embodiment, where the controller during estimation of the payload is configured to provide user instructions to a user. The screens illustrated in FIGS. 7a and 7b corresponds to the screens illustrated in FIGS. 6a and 6b and only the differences will be described.

In this embodiment a second representation 796 the robot tool flange is shown upon the display and indicates at least one of the different orientations of the robot tool flange. In FIG. 6a, the first representation 692a indicates the desired orientation of the robot tool flange in the 1^{st} orientation and is provided as an image 693a illustrating a possible configuration of the robot arm with the robot tool flange arranged in the 1^{st} orientation. Further an orientation symbol 694a indicating the orientation of the robot tool flange is also shown. A gravity symbol indicating the orientation of gravity 695 can also be provided at the display. In FIG. 6b the first representation 692b indicates the desired orientation of the robot tool flange in the 2^{nd} orientation and is provided as an image 693b illustrating a possible configuration of the robot arm with the robot tool flange arranged in the 2nd orientation and symbol 694b indicates the orientation of the robot tool flange in the 2^{nd} orientation.

In this embodiment a second representation 796 indicates the actual orientation of the robot tool flange and is provided as an image 797 illustrating the actual configuration the robot arm. In the illustrated embodiment the image 797 is illustrated as a part of the robot arm, however it is noticed the image also can show the entire robot. The image of the robot in the actual configuration changes if the configuration of the robot is changed.

In this embodiment the first representation 792a, 792b the robot tool flange respectively in the first and second orientation are is provided in dotted lines in order to differentiate the first representation form the second representation.

This assisted the user when arranging the robot tool flange in the desired orientations, as the user can associate the second representation of the actual robot position with the presentation with of the desired orientation and there is thereby guided to which orientation the robot tool flange should be arranged.

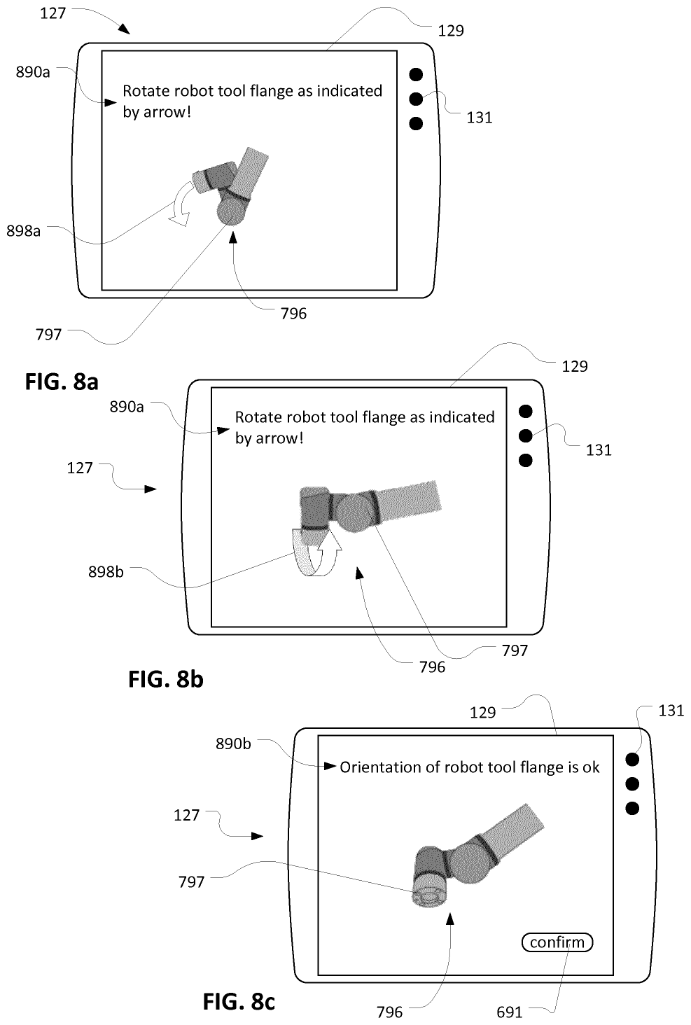

FIGS. 8a, 8b and 8c illustrate an interface device 127 of the robot arm illustrated in FIG. 1 and illustrates examples of an embodiment, where the controller during estimation of the payload is configured to provide user instructions to a user. In FIGS. 8a and 8b the user instruction is provided as a command prompt 890a instructing the user to: “Rotate robot tool flange as indicated by arrow!”. A second representation 796 indicates the actual orientation of the robot tool flange and is provided as an image 797 illustrating the actual configuration the robot arm. An arrow 898 indicates to direction of rotation that the user should rotate the robot tool flange in order to arrange the robot tool flange in one of the desired orientations. The direction of the arrow is determined based on the actual configuration of the robot arm and information relating to the desired orientation of the robot tool flange, such as an actual orientation of the robot arm, an orientation relative to the previous orientations where the force and torques have been obtained. For instance, as illustrated in FIGS. 8a and 8b the arrow 898a in FIG. 8a has changed to arrow 898b in FIG. 8b in response to a change to the actual orientation of the robot arm.

In FIG. 8c the robot tool flange has been arranged in a desired orientation and a command prompt 890b instructing “Orientation of robot tool flange is ok” is displayed on the display. Hereby the user is informed that the robot tool flange is arranged in an orientation for obtaining the payload information of the payload. The user can then confirm the orientation where after the controller proceeds.

The illustrated screen of the interface device only serves to illustrate possible embodiments of the user instructions, first representation, second representation of the robot tool flange can be used to assist a user utilizing the robot and method according to the present invention for obtaining payload information of a payload attached to the robot tool flange. It is noted that the illustrate screens have been simplified and the skilled person will be able to provide further elements such as control icons, menus additional graphics to the screens.

### BRIEF DESCRIPTION OF FIGURE REFERENCES

101: robot arm
103a-103e: robot joint
105: robot base
107: robot tool flange
109: payload
111a-111f: axis of rotation
113: rotation arrow
115: robot tool flange coordinate system
117: center of mass of payload
119: robot base coordinate system
121: direction of gravity
125: controller
127: Interface device
129: display
131: input device
250: arranging robot tool flange in a plurality of orientations
251: arranging the robot tool flange in a first orientation
252: obtaining the orientation of the robot tool flange
253: obtaining the force and torque of provide to the robot tool flange
254: change orientation of robot tool flange
255: verifying that force-torque have been obtained at at least two different orientations
256: verifying orientation of the robot tool flange
260: obtain mass of payload based
270: obtain pose of payload
280: control robot based on obtained mass and pose of payload
361: obtain force difference between for at two different orientations
362: obtain mass of payload based on obtained force difference
371: obtain torque difference between two orientations
372: obtain pose payload based on obtained torque difference
463: provide guess of the mass the payload 464: provide expected force at two orientations based on guess of mass
465: determine an expected force difference between two of the expected forces
466: determine force error based on obtained force difference and expected force difference
467: provide mass of payload by minimizing force error
468: loop
573: provide guess of the pose the payload
574: provide expected torque at two orientations based on guess of pose
575: determine an expected torque difference between two of the expected torques
576: determine torque error based on obtained torque difference and expected torque difference
577: provide pose of payload by minimizing torque error
578: loop
690a: command prompt: “Arrange robot flange in 1^{st} orientation!”.
690b: command prompt: “Change orientation of robot tool flange into a 2^{nd} orientation in relation to gravity”
691: confirmation icon
692a-692b: first representation of the robot tool flange
693a: image illustrating a possible configuration of part of the robot arm with the robot tool flange arranged in the 1^{st} orientation
693b: image illustrating a possible configuration of part of the robot arm with the robot tool flange arranged in the 2^{nd} orientation
694a-694b: symbol indicating orientation of robot tool flange
695: orientation of gravity
792a-792b: first representation of the robot tool flange
796: second representation of the robot tool flange
797: image illustrating actual configuration of part of robot
890a: command prompt: “Rotate robot tool flange as indicated by arrow!”.
890b: command prompt: “Orientation of robot tool flange is ok”
898a-898b: arrow indicating to direction of rotation

1. A method of obtaining information about a payload attached to a tool flange of a robotic arm, where the robotic arm comprises joints connecting a robot base to the tool flange, and where the method comprise:
arranging the tool flange in different orientations;
at each of the different orientations, obtaining a force and a torque on the tool flange caused by effects of gravity acting on the payload, the force being obtained using a force-torque sensor at the tool flange;
obtaining a mass of the payload based on forces on the tool flange produced in at least two of the different orientations; and
obtaining a pose of the payload relative to the tool flange based on the mass of the payload and torques on the tool flange produced in the at least two different orientations;
wherein arranging the tool flange in the different orientations comprises rotating the tool flange relative to a direction of gravitational force such that an angle between the tool flange and the direction of gravitational force is different for each of the different orientations.

2. The method of claim 1, wherein obtaining the mass of the payload comprises:
obtaining at least one force difference, where the at least one force difference comprises a difference between two of the forces produced at two of the different orientations; and
determining the mass of the payload based on the at least one force difference.

3. The method of claim 2 wherein obtaining the mass of the payload comprises:
obtaining an initial guess of the mass of the payload;
for at least two of the different orientations of the tool flange, obtaining an expected force to be produced in the tool flange by a payload having a mass corresponding to the initial guess;
determining an expected force difference between at least two expected forces in the at least two different orientations of the tool flange; and
determining a force error comprising a difference between the force difference and the expected force difference;
wherein the mass of the payload is obtained by minimizing the force error.

4. The method of claim 1, wherein obtaining the pose comprises:
obtaining at least one torque difference, where the at least one torque difference is based on a difference between at least two torques produced at the different orientations of the tool flange;
wherein the pose is based on the at least one torque difference and the mass.

5. The method of claim 4, wherein obtaining the pose comprises:
obtaining an initial guess of the pose of the payload;
for the at least two different orientations, obtaining an expected torque on the tool flange caused by the payload having a pose corresponding to the initial guess;
determining at least one expected torque difference between at least two expected torques; and
determining a torque error comprising a difference between the at least one torque difference and the at least one expected torque difference;
wherein the pose is obtained by minimizing the torque error.

6. The method acc of claim 1, wherein arranging the tool flange a comprises rotating the tool flange around an axis that is non-parallel to, and non-perpendicular to, the direction of gravitational force.

7. The method of claim 1, wherein the orientation of the tool flange is changed by at least 20° relative to a least one other orientation of the tool flange.

8. The method of claim 1, wherein the orientation of the tool flange is changed by between 110° and 130° relative to a least one other orientation of the tool flange.

9. The method of claim 1, wherein the tool flange is arranged in four different orientations.

10. A method of controlling a robotic arm, the robotic arm comprising joints connecting a base of the robotic arm to a tool flange of the robotic arm, the tool flange for holding a payload, the method comprising:
obtaining a mass of the payload based on differences in force applied by the payload to the tool flange at different orientations of the tool flange;
obtaining a pose of the payload relative to the tool flange based on differences in torque applied by the payload to the tool flange at the different orientations; and
controlling the joints based on a kinematic model of the robot and information about the payload, where the information comprises the mass of the payload and the pose of the payload relative to the tool flange.

11. A robot system comprising:
a tool flange for holding a payload;
a robotic arm comprising joints connecting a base of a robot to the tool flange;
at least one controller configured to control the joints based on a kinematic model of the robot and information about the payload, the information comprising a mass of the payload and a pose of the payload relative to the tool flange;
wherein the controller is configured to perform operations comprising:
obtaining the mass and the pose based on forces and torques on the tool flange caused by the payload; and
obtaining the forces and the torques based on inputs from a force-torque sensor attached to the tool flange, the inputs being obtained when the tool flange is at different orientations relative to a direction of gravitational force, where an angle between the tool flange and the direction of gravitational force is different for at least some of the different orientations.

12. The robot system of claim 11, wherein the operations comprise providing instructions to a user, the instructions instructing the user to change an orientation of the tool flange relative to the direction of gravitational force.

13. The robot system of claim 12, wherein the instructions instruct the user to rotate the tool flange around an axis that is non-parallel to, and non-perpendicular to, the direction of gravitational force.

14. The robot system of claim 11, further comprising:
an interface device comprising a display device for displaying a first representation of the tool flange, the first representation corresponding to at least one of the different orientations.

15. The robot system of claim 14, wherein the display device is also for displaying a second representation of the tool flange, the second representation showing an orientation of the tool flange relative to the first representation.

16. The robot system of claim 11, further comprising:
an interface device comprising a display device for displaying a representation of the tool flange, where the representation indicates an actual orientation of the tool flange, and where the display device is also for displaying an arrow indicating a direction to rotate the tool flange.

17. The robot system of claim 11, wherein the mass of the payload is obtained by performing operations comprising:
obtaining at least one force difference, where the at least one force difference comprises a difference between two of the forces obtained at two of the different orientations; and
determining the mass of the payload based on the at least one force difference.

18. The robot system of claim 17, wherein the mass of the payload is obtained by performing operations comprising:
obtaining an initial guess of the mass of the payload;
for at least two of the different orientations of the tool flange, obtaining an expected force to be applied to the tool flange by a payload having a mass corresponding to the initial guess;
determining an expected force difference between at least two expected forces in the at least two of different orientations; and
determining a force error comprising a difference between the force difference and the expected force difference;
wherein the mass of the payload is obtained by minimizing the force error.

19. The robot system of claim 11, wherein the pose is obtained by performing operations comprising:
obtaining at least one torque difference, where the at least one torque difference is based on a difference between at least two torques obtained at the different orientations of the tool flange, where the pose is based on the torque difference and the mass.

20. The robot system bot of claim 19, wherein the pose is obtained by performing operations comprising:
obtaining an initial guess of the pose of the payload;
for the at least two different orientations, obtaining an expected torque on the tool flange caused by the payload having a pose corresponding to the initial guess;
determining at least one expected torque difference between at least two expected torques; and
determining a torque error comprising a difference between the at least one torque difference and the at least one expected torque difference;
wherein the pose is obtained by minimizing the torque error.
